(19) United States
(12) Patent Application Publication
(10) Pub. No.: US 2006/0040107 A1
(43) Pub. Date: Feb. 23, 2006

(54) Fridge mats

(76) Inventor: Shanon Bassi, Martinez, CA (US)

Correspondence Address: SHANON BASSI, 2101 SHADOW LAKE PLACE, MARTINEZ, CA, 94553, US

(21) Appl. No.: 10/923,998

(22) Filed: Aug. 20, 2004

(51) Int. Cl. B32B 9/04

(52) U.S. Cl. 428/411.1

(57) ABSTRACT

A new way of using plastic material to maintain cleanliness of the refrigerator shelf.

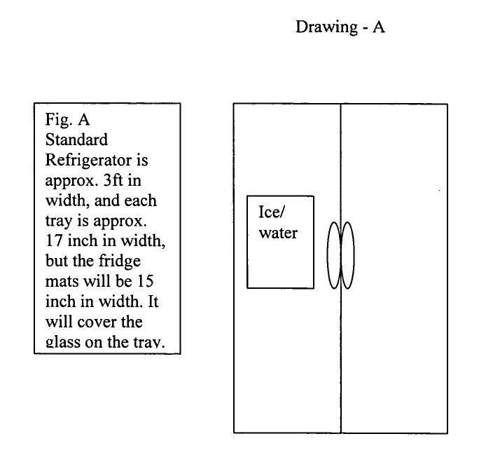

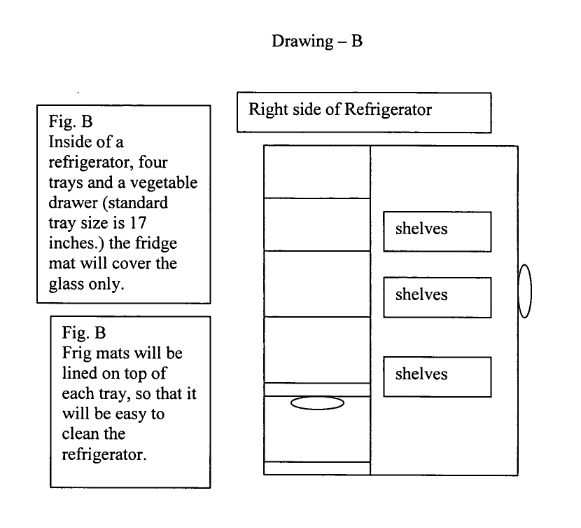

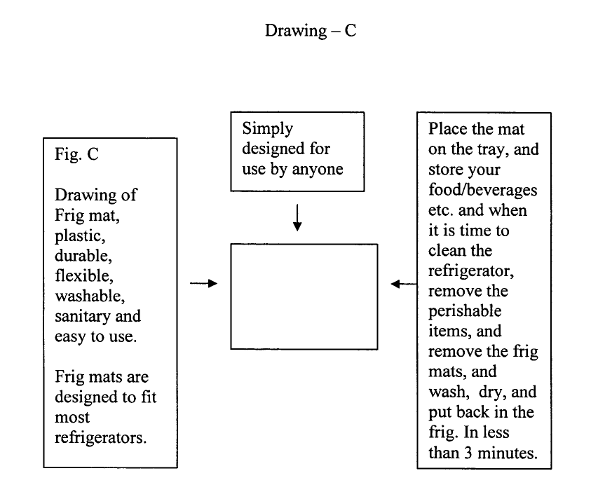

### FIELD OF INVENTION

Fridge Mats are designed to promote a sanitary lifestyle. Instead of having to remove each tray from the refrigerator to clean the glass, which you would become very tired of cleaning on a monthly basis, you would only have to remove the mats, wash and dry the mats, and put back in the frig.

This idea would help housewives, mothers or anyone young or old who are too busy to spend hours cleaning the refrigerator. By using fridge mats, you would prevent mishandling of the glass trays, i.e. accidentally dropping the glass, which would be costly and time consuming to replace, or the comers of the glass chipping, and of course, heavy handling. The trays are heavy.

Fridge mats are durable plastic, flexible mats that can be reused. They are designed to help busy people keep a healthy, sanitary lifestyle. I thought of this idea when I was cleaning my refrigerator. I had to take each tray out, remove the glass from the plastic tray, clean the tray thoroughly, and then clean the glass, and then dry both the tray and glass. In some cases, I just waited for the glass and tray to dry on their own, and then struggle with putting the tray back in the refrigerator while attempting to prevent the tray from falling out of my hands. Mind you, a standard refrigerator has At least four to five trays.

After I had cleaned the trays along with the glass, an hour had passed, and I was too tired to clean the freezer side of the refrigerator. At that moment, I thought of the Frig mat idea, therefore, I researched the internet to see if there was anything related to refrigerator mats. I even checked the USPTO website for any invention on this idea, and I came up with nothing.

Therefore, I am the first person to invent such a great idea. Frig mats would be beneficial to housewives, bachelors, people with busy work schedules, elderly people, handicapped persons, and people who enjoy cleaning, without spending too much time. Frig mats will become a need and a necessity for all households, young and old.

Cleaning my refrigerator was very tiring because It was too much work, but if I had the Frig mats, all I would do is remove the perishable items from the fridge, remove the mat, wash the mat, dry it, and put it back in the refrigerator, then put the perishable items back in the refrigerator, doing that will take approximately, three minutes or less per tray. I would not have to worry about the glass breaking, falling, cracking, nor will I have to wait till the glass dries, or spend time drying it. Fridge mats is a thin, flexible, plastic lining of the tray.

1. I, Shanon Bassi, claim as my invention is Fridge Mats. Fridge Mats are plastic liners that are placed on the trays in the refrigerator.
